(19) United States
(12) Patent Application Publication
(10) Pub. No.: US 2015/0137929 A1
(43) Pub. Date: May 21, 2015

(54) MULTILAYER INDUCTOR

(71) Applicant: SAMSUNG ELECTRO-MECHANICS CO., LTD., Suwon (KR)

(72) Inventor: Yong Sun PARK, Suwon (KR)

(73) Assignee: SAMSUNG ELECTRO-MECHANICS CO., LTD., Suwon (KR)

(21) Appl. No.: 14/184,372

(22) Filed: Feb. 19, 2014

(30) Foreign Application Priority Data
Nov. 21, 2013 (KR) 10-2013-0142158

(51) Int. Cl. H01F 27/28

(52) U.S. Cl. CPC H01F 27/2804; H01F 2027/2809
USPC 336/200

(57) ABSTRACT

There is provided a multilayer inductor including: a body in which a plurality of dielectric layers are stacked in a width direction; a plurality of first and second internal electrode patterns disposed to oppose each other, having the dielectric layer therebetween and each led to positions of a lower surface of the body spaced apart from each other; and first and second external electrodes formed on a lower surface of the body to be spaced apart from each other and electrically connected to the first and second internal electrode patterns, respectively.

### CROSS-REFERENCE TO RELATED APPLICATION

This application claims the benefit of Korean Patent Application No. 10-2013-0142158 filed on Nov. 21, 2013, with the Korean Intellectual Property Office, the disclosure of which is incorporated herein by reference.

### BACKGROUND

The present disclosure relates to a multilayer inductor.

Electronic components using a ceramic material include a capacitor, an inductor, a piezoelectric element, a varistor, a thermistor, and the like.

An inductor, one of the ceramic electronic components as described above, is one of important passive devices configuring an electronic circuit together with a resistor and a capacitor, and is used in components for removing noise or configuring an LC resonance circuit.

The inductor may be variously divided according to the structure thereof. For example, the inductor may be divided into a winding or thin film inductor manufactured by winding or printing a coil around a ferrite core and forming electrodes at both ends of the core, a multilayer inductor manufactured by printing an internal electrode pattern on a dielectric material or a sheet formed of a dielectric material, or the like, and stacking a plurality of dielectric materials or sheets, and the like.

Among them, the multilayer inductor has advantages in miniaturizing a product, decreasing a thickness of the product, and improving DC resistance as compared to the winding inductor, such that the multilayer inductor has mainly been used in a power supply circuit requiring miniaturization and high current of the product, or the like.

Generally, in the multilayer inductor, an internal electrode pattern is formed by printing a conductor in a coil shape on a plurality of dielectric layers stacked in a thickness direction, and a coil part is formed by vertically connecting the internal electrode patterns to each other.

The coil part is led to both end surfaces of a chip in a length direction, and an external electrode is formed so as to be connected to the coil part led to both end surfaces of the chip.

However, in the multilayer inductor according to the related art, eddy current may be generated due to interference of parasitic capacitance generated between the internal electrode pattern and the external electrode at the time of mounting the multilayer inductor on a substrate with the substrate, such that characteristics of the chip may be deteriorated.

In addition, a configuration of an internal coil may be changed according to directions input part/output parts of current, such that at the time of mounting the multilayer inductor on the substrate, a problem may occur in which design and matching are changed due to a change in magnetic flux direction as described above. In order to prevent this problem, in the multilayer inductor of the related art, a separate marking indicating a direction of a coil should be marked on the chip.

Meanwhile, generally, since in an electronic component in which a lower surface thereof becomes a mounting surface, a portion on which an external electrode is mounted is limited to a lower surface of a chip, adhesion strength of the external electrode is weak, such that it is highly likely to generate a defect in which the external electrode is separated from the chip.

A multilayer inductor in which a lower surface thereof becomes a mounting surface has been disclosed in the following Patent Document 1.

### RELATED ART DOCUMENT

(Patent Document 1) Korean Patent Laid-open Publication No. 2012-0122590

### SUMMARY

An aspect of the present disclosure may provide a multilayer inductor capable of increasing a degree of freedom in design, decreasing parasitic capacitance with an external electrode, and improving adhesion strength with the external electrode.

According to an aspect of the present disclosure, a multilayer inductor may include: a body in which a plurality of dielectric layers are stacked in a width direction; first and second external electrodes formed on a lower surface of the body to be spaced apart from each other; a coil part including a first internal electrode pattern led to the lower surface of the body and connected to the first external electrode, a second internal electrode pattern led to the lower surface of the body and connected to the second external electrode, and a plurality of third internal electrode patterns connecting the first and second internal electrode patterns to each other; and at least one of first and second dummy patterns led to the lower surface of the body to thereby be connected to the first and second external electrodes, respectively, and disposed to not contact the coil part.

According to another aspect of the present disclosure, a multilayer inductor may include: a body in which a plurality of dielectric layers are stacked in a width direction; first and second external electrodes formed on a lower surface of the body so as to be spaced apart from each other; a coil part including a first internal electrode pattern led to the lower surface of the body and connected to the first external electrode, a second internal electrode pattern led to the lower surface of the body and connected to the second external electrode, and a plurality of third internal electrode patterns connecting the first and second internal electrode patterns to each other; a cover layer formed on both side surfaces of the body; and at least one of first and second dummy patterns formed on one surface of the cover layer to be led to the lower surface of the body to thereby be connected to the first and second external electrodes, respectively.

The dummy pattern may be formed on the dielectric layer on which the first or second internal electrode pattern is formed.

The dummy pattern may be formed on the dielectric layer on which the third internal electrode pattern is formed.

The lower surface of the body may be a surface mounted on a substrate.

The first to third internal electrode patterns may be formed in a loop shape along an edge of the dielectric layer.

The first and second external electrodes may be formed to be spaced apart from an edge of the lower surface of the body.

A length of each of the first and second external electrodes may be smaller than ⅓ of a length of the body.

A width of the first and second external electrodes may be greater than or equal to ½ of a width of the body.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a transparent perspective view schematically illustrating a multilayer inductor according to an exemplary embodiment of the present disclosure;

FIG. 2 is an exploded perspective view illustrating a structure in which dielectric layers and coil patterns of the multilayer inductor according to an exemplary embodiment of the present disclosure are formed;

FIG. 3 is a plan view illustrating the coil pattern and dummy patterns of the multilayer inductor according to an exemplary embodiment of the present disclosure;

FIG. 4 is a transparent front view schematically illustrating the multilayer inductor according to an exemplary embodiment of the present disclosure;

FIG. 5 is a graph illustrating a comparison result of inductances of a horizontal multilayer inductor according to the related art and a vertical multilayer inductor according to an exemplary embodiment of the present disclosure; and

FIG. 6 is a graph illustrating a comparison result of Q values of the horizontal multilayer inductor according to the related art and the vertical multilayer inductor according to an exemplary embodiment of the present disclosure.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

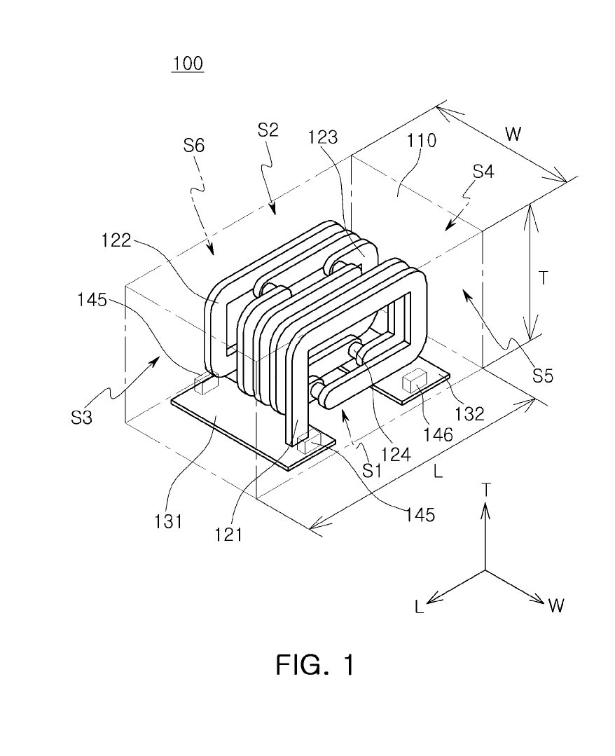

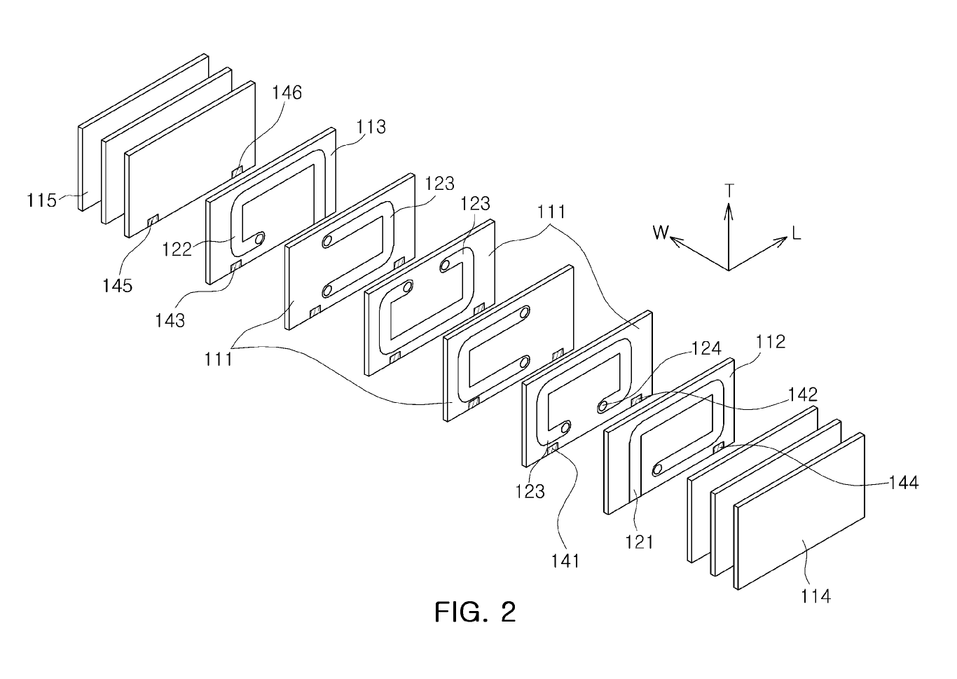

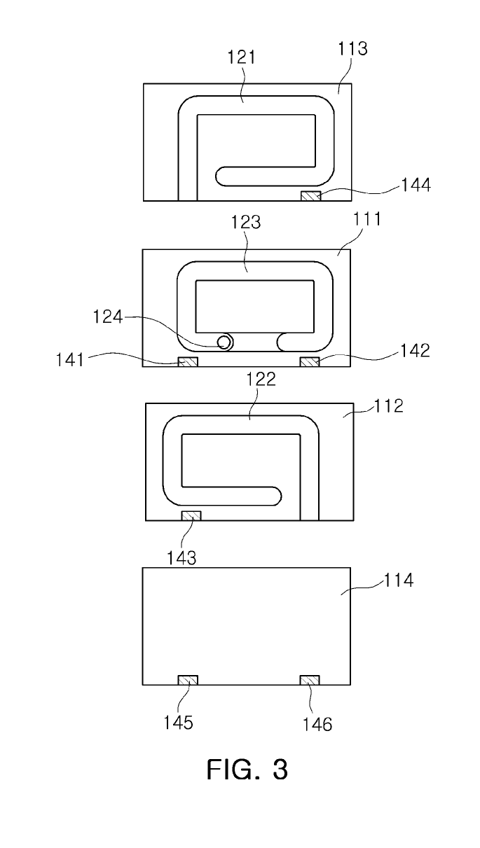

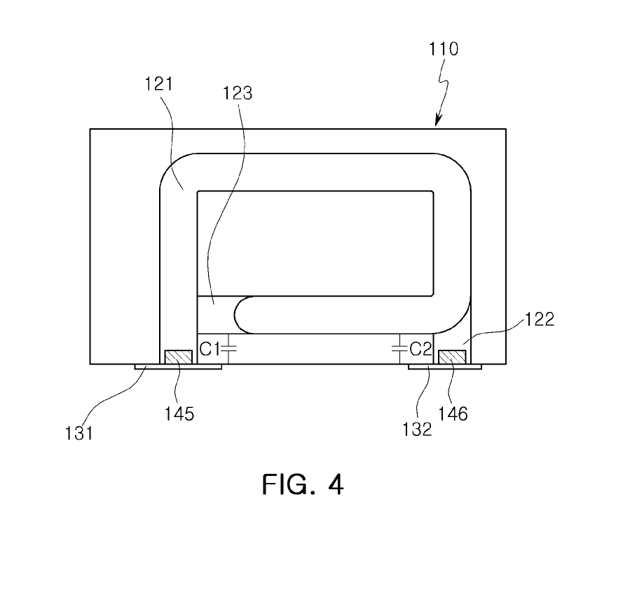

FIG. 1 is a transparent perspective view schematically illustrating a multilayer inductor according to an exemplary embodiment of the present disclosure, FIG. 2 is an exploded perspective view illustrating a structure in which dielectric layers and coil patterns of the multilayer inductor according to an exemplary embodiment of the present disclosure are formed, FIG. 3 is a plan view illustrating the coil pattern and dummy patterns of the multilayer inductor according to an exemplary embodiment of the present disclosure, and FIG. 4 is a transparent front view schematically illustrating the multilayer inductor according to an exemplary embodiment of the present disclosure.

Directions will be defined in order to clearly describe exemplary embodiments of the present disclosure. “L”, “W” and “T” illustrated in the accompanying drawings refer to “a length direction”, “a width direction”, and “a thickness direction”, respectively. Here, the width direction may be the same as a direction in which dielectric layers are stacked.

Referring to FIGS. 1 through 4, the multilayer inductor 100 according to an exemplary embodiment of the present disclosure may include a body 110, first and second external electrodes 131 and 132, first to third internal electrode patterns 121 to 123, and first and second dummy patterns 141 to 146.

The body 110 may be formed by stacking a plurality of dielectric layers 111 to 113 in the width direction and then sintering the stacked dielectric layers. In this case, a shape and a dimension of the body 110 and the number of stacked dielectric layers 111 to 113 are not limited to those of the present exemplary embodiment illustrated in the accompanying drawings.

Since in the multilayer inductor 100 according to this exemplary embodiment, which is a vertical multilayer inductor, an internal coil has the same rotation direction regardless of a direction of an input/output part of a coil part, horizontal directionality of the body 110 is removed, such that a defect generated due to misalignment of a mounting direction in the existing horizontal multilayer inductor may be prevented, and there is no need to mark a separate marking indicating a direction of a coil.

Further, in the vertical multilayer inductor according to this exemplary embodiment, eddy current generated in a horizontal multilayer inductor according to the related art due to interference of parasitic capacitance generated between an internal electrode pattern and an external electrode at the time of mounting the multilayer inductor on a substrate with the substrate may be significantly decreased.

A shape of the body 110 is not particularly limited, but may be, for example, a hexahedral shape. In this exemplary embodiment, for convenience of explanation, surfaces of the body 110 opposing each other in the thickness direction may be defined as first and second main surfaces S1 and S2, surfaces opposing each other in the length direction and connecting the first and second main surfaces S1 and S2 to each other may be defined as first and second end surfaces S3 and S4, and surfaces opposing each other in the width direction and vertically intersecting with the first and second end surfaces S3 and S4 may be defined as first and second side surfaces S5 and S6.

When the dielectric layers 111 to 113 are stacked in the width direction as described above, since a length-thickness surface is used as a stacking surface, a cross-sectional area of the coil may be increased as compared to the case of using a width-thickness surface as a stacking surface of the related art, such that the number of stacked internal electrode patterns may be decreased, and the product may be miniaturized based on the same capacity.

In addition, the plurality of dielectric layers 111 to 113 configuring the body 110 may be in a sintered state. Adjacent dielectric layers 111 to 113 may be integrated such that it may be difficult to confirm a boundary therebetween without using a scanning electron microscope (SEM).

At least one of cover layers 114 and 115 may be formed on the first and second side surfaces S3 and S4, respectively, in the width direction of the body 110.

The cover layers 114 and 115 may have the same material and configuration as those of the dielectric layers 111 to 113 except that internal electrodes are not included therein.

These cover layers 114 and 115 may basically serve to prevent the first to third internal electrode patterns 121 to 123 from being damaged by physical or chemical stress.

The dielectric layers 111 to 113 may be sheets manufactured using a dielectric material or a magnetic material, and these dielectric layers 111 to 113 may be manufactured as thin dielectric sheets by a doctor blade method, or the like, after mixing the dielectric material or ceramic magnetic material powder such as ferrite powder, or the like, with a solvent together with a binder, or the like, and then uniformly dispersing the dielectric material or ceramic magnetic material powder in the solvent using a ball milling method, or the like.

The first to third internal electrode patterns 121 to 123 may be connected to each other in the width direction through a via electrode 124 to configure coil implementing inductance and be formed by printing a conductive paste containing a conductive metal onto the dielectric layers 111 to 113 at a predetermined thickness.

In this case, the first to third internal electrode patterns 121 to 123 may be electrically insulated from each other by the dielectric layers 111 to 113 disposed therebetween.

The thickness and the number of the first to third internal electrode patterns 121 to 123 as described above may be variously determined according to the electric properties such as an inductance value, or the like, required in the multilayer inductor 100.

In addition, the first to third internal electrode patterns 121 to 123 may be formed in a loop shape along edges of the dielectric layers 111 to 113 in order to increase inductance. Preferably, the first to third internal electrode patterns 121 to 123 may be formed in a maximal loop shape along the edges of the dielectric layers 111 to 113.

Further, one of silver (Ag), palladium (Pd), platinum (Pt), nickel (Ni), and copper (Cu), an alloy thereof, or the like, may be used as the conductive metal contained in the conductive paste forming the first to third internal electrode patterns 121 to 123, but the present disclosure is not limited thereto.

In addition, a screen printing method, a gravure printing method, or the like, may be used as a printing method of the conductive paste, but the present disclosure is not limited thereto.

Further, one end portions of the first and second internal electrode patterns 121 and 122 may each be led to the first main surface S1 of the body 110, and the exposed one end portions may be led to positions of the first main surface of the body 110 spaced apart from each other, respectively, to thereby form a lower surface electrode structure.

In this case, lead parts of the first and second internal electrode patterns 121 and 122 may have the same width as that of the internal electrode pattern in the body 110, and if necessary, the lead parts may have a width wider than that of the internal electrode pattern in the body 110 to thereby increase electric connectivity with the external electrode.

In addition, although the case in which each of the first internal electrode pattern 121 and the second internal electrode pattern 122 are configured singularly is illustrated and described in this exemplary embodiment, the present disclosure is not limited thereto, but if necessary, a plurality of first and second internal electrode patterns 121 and 122 may each be included.

The first and second external electrodes 131 and 132 may be formed on the first main surface S1 of the body 110 spaced apart from each other in order to provide a lower mounting surface at positions corresponding to the lead parts of the first and second internal electrode patterns 121 and 122 in the width direction of the body 110, to thereby be electrically connected to the first and second internal electrode patterns 121 and 122, respectively.

Therefore, the lower surface of the body 110, that is, the first main surface S1 may become the mounting surface mounted on the substrate.

In this case, the first and second external electrodes 131 and 132 may be formed spaced apart from an edge of the first main surface S1 of the body 110.

In addition, a length of each of the first and second external electrodes 131 and 132 may be smaller than ⅓ of a length of the body 110.

In the case in which the length of each of the first and second external electrodes 131 and 132 is greater than ⅓ of the length of the body 110, generation of an eddy current loss between the external electrode and a metal layer of a set contacting the external electrode may be increased, such that characteristics of the inductor may be deteriorated. In addition, at the time of mounting the set, distortion of fine alignment may be generated, such that a short-circuit may occur in each of the terminals.

In addition, a width of each of the first and second external electrodes 131 and 132 may be greater than or equal to ½ of a width of the body 110.

In the case in which the width of the first and second external electrodes 131 and 132 is smaller than ½ of the width of the body 110, adhesion force with the set may be decreased due to a decrease in contact area.

The first and second external electrodes 131 and 132 as described above may be formed on the first main surface S1 of the body 110 using a conductive paste containing a conductive metal by a printing or sputtering method. In this case, the conductive metal may be silver (Ag), nickel (Ni), copper (Cu), or an alloy thereof, but the present disclosure is not limited thereto.

Meanwhile, a plating layer (not illustrated) may be formed on the first and second external electrodes 131 and 132 as needed.

The plating layer serves to increase adhesion strength between the multilayer inductor 100 and the substrate at the time of mounting the multilayer inductor 100 on the substrate using a solder.

The plating layer as described above may have a structure configured of a nickel (Ni) plating layer formed on the first and second external electrodes 131 and 132 and a tin (Sn) plating layer formed on the nickel plating layer, but the present disclosure is not limited thereto.

In the case of a structure in which an external electrode of the related art is formed on both end surfaces of the body, parasitic capacitance generated between layers, or between an internal coil and the external electrode, may be large. In order to decrease the parasitic capacitance generated between the layers as described above, a method of decreasing a line width or increasing a distance between the layers may be used.

Further, in order to decrease the parasitic capacitance between the internal coil and the external electrode, a method of decreasing an area of an internal core to increase a distance between the internal coil and the external electrode may be used. However, in order to secure capacity of the inductor, since the number of turns of the coil needs to be increased by increasing the number of stacked internal electrode patterns, a size of the product may be increased.

In this exemplary embodiment, the inductor has a mounting structure in which the first and second external electrodes 131 and 132 are formed on the first main surface S1 of the body 110 so that the lower surface becomes a mounting surface, such that at the time of mounting the inductor on the substrate, a mounting area may be decreased. Therefore, a degree of freedom in design may be increased, and the inductor may have excellent durability even in the case of sustaining external force or impact vertically applied to the body 110.

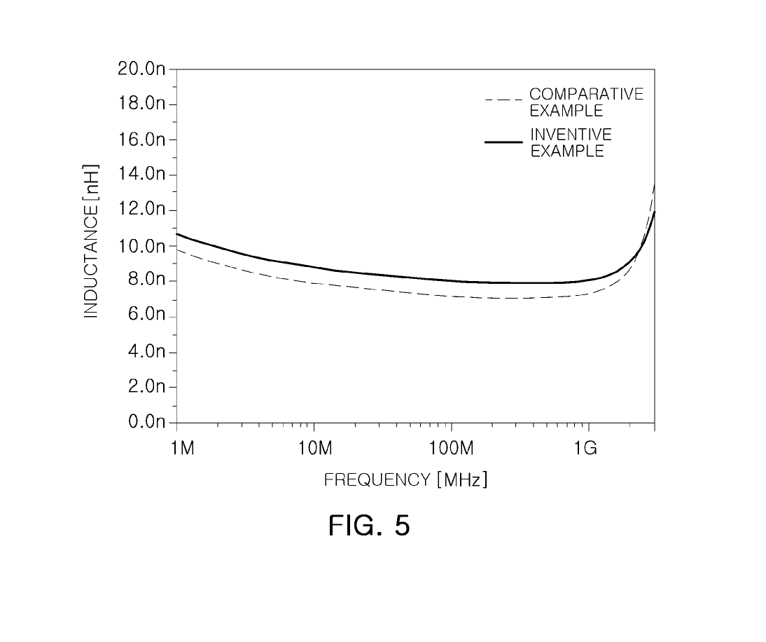

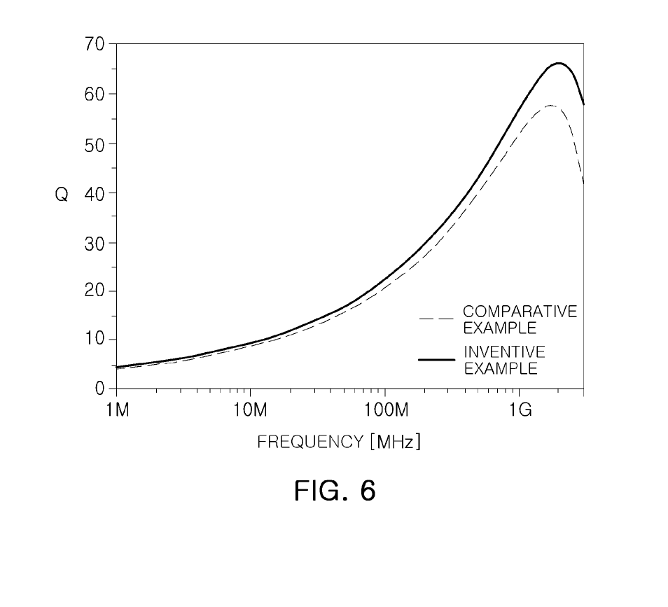

FIG. 5 is a graph illustrating a comparison result of inductances of a horizontal multilayer inductor according to the related art and a vertical multilayer inductor according to an exemplary embodiment of the present disclosure, and FIG. 6 is a graph illustrating a comparison result of Q values of the horizontal multilayer inductor according to the related art and the vertical multilayer inductor according to an exemplary embodiment of the present disclosure.

Referring to FIGS. 5 and 6, it may be confirmed that in the case in which the horizontal multilayer inductor and the vertical multilayer inductor were designed so as to have the same core area and the same number of layers as each other in the inductor in Inventive Examples, inductance was increased by about 11% to 12%, and the Q value was increased by about 7% to 8%. In addition, it may be appreciated that a self-resonant frequency (SRF) further moved toward a high frequency.

Therefore, the vertical multilayer inductor according to this exemplary embodiment may have inductance, a Q value, and a SRF higher than those of the horizontal multilayer inductor according to the related art having the same core area and the same number of layers, such that the number of layers of the entire internal electrode pattern may be decreased, and a degree of freedom in design according to space arrangement may be increased.

The first and second dummy patterns 141 to 146 may be formed to be led to the first main surface S1 of the body 110 on which the first and second external electrodes 131 and 132 are formed, to thereby be connected to the first and second external electrodes 131 and 132, respectively, and disposed to not contact the first to third internal electrode patterns 121 to 123 of the coil part.

Therefore, adhesion strength between the first and second external electrodes 131 and 132 and the body 110 may be improved while not affecting characteristics of a chip.

In this case, the first and second dummy patterns 143 and 144 may be formed on the dielectric layers 112 and 113, on which the first or second internal electrode patterns 121 and 122 are formed, together with the first or second internal electrode pattern 121 or 122.

In this case, since a short-circuit may occur when the first and second dummy patterns contact the first or second internal electrode pattern 121 or 122, the first and second dummy patterns 141 to 146 need to be spaced part from the first or second internal electrode pattern 121 or 122 by a predetermined distance.

Further, the first and second dummy patterns 141 and 142 may be formed on the dielectric layer 111, on which the third internal electrode pattern 123 is formed, together with the third internal electrode pattern 123.

In this case, the dummy pattern is less restricted by space as compared to the dummy pattern formed on the dielectric layers 112 and 113 on which the first and second internal electrode patterns 121 and 122 are formed.

In this case, since a short-circuit may occur when the first and second dummy patterns 141 and 142 contact the third internal electrode pattern 123, the first and second dummy patterns 141 and 142 need to be spaced apart from the third internal electrode pattern 123 by a predetermined distance.

In addition, the first and second dummy patterns 145 and 146 may be formed on the cover layers 114 and 115. In this case, the dummy pattern is less restricted by space as compared to the dummy pattern formed on the dielectric layers 112 and 113 on which the first and second internal electrode patterns 121 and 122 are formed and the dummy pattern formed on the dielectric layer 111 on which the third internal electrode pattern 123 is formed.

A height of the first and second dummy patterns 141 to 146 as described above may be adjusted so as not to contact the first to third internal electrode patterns 121 to 123 configuring the coil part. In this case, a width and a thickness of the first and second dummy patterns 141 to 146 may be appropriately adjusted according to the size and thickness of the internal electrode pattern.

In this case, the first and second dummy patterns 141 to 146 may be formed so that the lead part of the first or second internal electrode pattern 121 or 122 and the first and second dummy patterns 141 to 146 are positioned on the same line in the width direction.

As set forth above, according to exemplary embodiments of the present disclosure, a defect generated due to misalignment of a mounting direction may be prevented by removing horizontal directionality of the body, and at the time of mounting the inductor to the substrate, the mounting area may be decreased due to the structure in which the external electrodes of the input part and output part are formed on the lower surface of the body, such that the degree of freedom in design may be increased. In addition, the parasitic capacitance with the external electrode may be decreased due to the vertical multilayer structure, such that product characteristics such as the inductance and Q factor may be improved. Further, adhesion strength of the external electrode may be improved due to the dummy pattern extended to the inside of the body.

While exemplary embodiments have been illustrated and described above, it will be apparent to those skilled in the art that modifications and variations could be made without departing from the spirit and scope of the present disclosure as defined by the appended claims.

What is claimed is:

1. A multilayer inductor, comprising:
a body in which a plurality of dielectric layers are stacked in a width direction;
first and second external electrodes formed on a lower surface of the body to be spaced apart from each other;
a coil part including a first internal electrode pattern led to the lower surface of the body and connected to the first external electrode, a second internal electrode pattern led to the lower surface of the body and connected to the second external electrode, and a plurality of third internal electrode patterns connecting the first and second internal electrode patterns to each other; and
at least one of first and second dummy patterns led to the lower surface of the body to thereby be connected to the first and second external electrodes, respectively, and disposed to not contact the coil part.

2. The multilayer inductor of claim 1, wherein the dummy pattern is formed on the dielectric layer on which the first or second internal electrode pattern is formed.

3. The multilayer inductor of claim 1, wherein the dummy pattern is formed on the dielectric layer on which the third internal electrode pattern is formed.

4. The multilayer inductor of claim 1, wherein the lower surface of the body is a surface mounted on a substrate.

5. The multilayer inductor of claim 1, wherein the first to third internal electrode patterns are formed in a loop shape along an edge of the dielectric layer.

6. The multilayer inductor of claim 1, wherein the first and second external electrodes are formed to be spaced apart from an edge of the lower surface of the body.

7. The multilayer inductor of claim 6, wherein a length of each of the first and second external electrodes is smaller than ⅓ of a length of the body.

8. The multilayer inductor of claim 6, wherein a width of the first and second external electrodes is greater than or equal to ½ of a width of the body.

9. A multilayer inductor, comprising:
a body in which a plurality of dielectric layers are stacked in a width direction;
first and second external electrodes formed on a lower surface of the body so as to be spaced apart from each other;
a coil part including a first internal electrode pattern led to the lower surface of the body and connected to the first external electrode, a second internal electrode pattern led to the lower surface of the body and connected to the second external electrode, and a plurality of third internal electrode patterns connecting the first and second internal electrode patterns to each other;
a cover layer formed on both side surfaces of the body; and
at least one of first and second dummy patterns formed on one surface of the cover layer to be led to the lower surface of the body to thereby be connected to the first and second external electrodes, respectively.

10. The multilayer inductor of claim 9, wherein the lower surface of the body is a surface mounted on a substrate.

11. The multilayer inductor of claim 9, wherein the first to third internal electrode patterns are formed in a loop shape along an edge of the dielectric layer.

12. The multilayer inductor of claim 9, wherein the first and second external electrodes are formed to be spaced apart from an edge of the lower surface of the body.

13. The multilayer inductor of claim 12, wherein a length of each of the first and second external electrodes is smaller than ⅓ of a length of the body.

14. The multilayer inductor of claim 12, wherein a width of the first and second external electrodes is greater than or equal to ½ of a width of the body.
